(19) United States
(12) Patent Application Publication
(10) Pub. No.: US 2023/0288372 A1
(43) Pub. Date: Sep. 14, 2023

(54) Systems and Methods for Separating Compounds of Similar Mass by Differential Mobility Spectrometry

(71) Applicant: DH Technologies Development Pte. Ltd., Singapore (SG)

(72) Inventors: Leigh BEDFORD, Concord (CA); Bradley SCHNEIDER, Bradford (CA)

(21) Appl. No.: 18/019,546

(22) PCT Filed: Feb. 3, 2021
(86) PCT No.: PCT/IB2021/050886

§ 371 Date: Feb. 3, 2023

Related U.S. Application Data
(60) Provisional application No. 62/969,492, filed on Feb. 3, 2020.

(51) Int. Cl. G01N 27/624; G01N 27/623

(52) U.S. Cl. CPC G01N 27/624; G01N 27/623

(57) ABSTRACT

A method and apparatus are provided for separating and distinguishing between isotopic or isobaric opioid and/or benzodiazepine species within a sample. The method comprises introducing ions of the sample to an inlet of a differential mobility spectrometer (DMS), introducing a transport gas to carry the ions through the DMS, supplying an acetate modifier to the transport gas to modify the differential mobility of the ions, transporting the ions through the DMS in the presences of the acetate modifier and selectively transporting each of the species by selectively applying a corresponding compensation voltage for that species to allow that species to transport through and exit from the DMS.

### FIELD

The present invention is directed to differential mobility spectrometers, and more particularly to systems and methods for separating compounds of similar mass, including isobaric species, in a differential mobility spectrometer.

### BACKGROUND

Differential Mobility Spectrometry (DMS) is a term used to refer to devices which are operative to separate ions based on their mobility through a transport gas in the presence of a separation field. Commonly the term DMS is limited to planar electrode devices with a homogenous field through the length of the cell, while the term high field-asymmetric waveform ion mobility spectrometry (FAIMS) is used to refer to devices with curved electrode geometries wherein the ions travel through inhomogeneous fields created by the curved electrodes. Since both types of devices utilise the same physical separation principle they are collectively referred to as “DMS” in the present application. A useful background of the technology is described in Schneider, B.B. et al., “Differential Mobility Spectrometry/Mass Spectrometry History, Theory, Design Optimization, Simulations, and Applications”, Mass Spectrometry Reviews, 2015, 9999, 1-51, Wiley Periodicals Inc. (DOI 10.1002/mas.21453), which is incorporated herein by reference (referred to herein as “DMS History”).

FIG. 1A provides a schematic of a planar DMS system, comprising 2 flat electrodes 120, 125 with an electrode driving source 130 applying an asymmetric separation voltage (SV) between the electrodes 120, 125. The SV includes a short high field component and a longer low field component of the opposite polarity. Ions are transported through the DMS 100 by a transport gas flow and drift towards one of the electrodes 120, 125 during the high field portion of the waveform and the other electrode 120, 125 during the lower field portion of the waveform. This results in a zig-zag trajectory with a net drift towards one or the other electrode, depending upon the difference between an ion’s high and low field mobility. A small DC potential (compensation voltage, CoV) is applied between the 2 flat electrodes 120, 125 to correct the trajectory for a given ion such that the transport gas flow carries the ions through the planar DMS outlet 115 where they may be analyzed, for instance in a downstream mass spectrometer (MS). The normalized difference between an ion’s high and low field mobility (shown in Equation 1) is referred to as the differential mobility function, or “alpha function” (α(E/N)),

$$α \left(\frac{E}{N}\right) = \frac{K \left(\frac{E}{N}\right) - K \left(0\right)}{K \left(0\right)} \qquad \text{Equation 1}$$

where K(E/N) is the field - dependent ion mobility and K(0) is the low field ion mobility.

The efficacy of DMS separation can be enhanced by the addition of chemical modifiers. Chemical modifiers significantly change the alpha function of the analyzed ions. Compounds entering the DMS system form clusters with the chemical modifier, and this alters the mobility characteristics. Under low electric field conditions chemical modifiers cluster with ions and under high electric fields these clusters decompose. This phenomenon is often referred to as the dynamic cluster/de-cluster model. The net effect of the dynamic cluster/decluster mechanism is that the differences between high- and low-field mobilities are amplified, yielding better separation power and increased peak capacity. Chemical modifiers that have been used to separate compounds, include for instance, alcohols, 2-propanol, acetonitrile, methanol, water, cyclohexane, ethylacetate, acetone and combinations thereof.

DMS can be used to filter out impurities in complex mixtures to improve specificity for target chemicals. The ability to reduce chemical noise accelerated DMS integration into systems that rely on the sensitive detection of target chemicals. One system which has benefited from DMS integration is mass spectrometry (MS). Around 1991, scientists first coupled DMS separation with MS. MS is an analytical technique that measures the mass-to-charge ratio of ions by producing a mass spectrum, which is a plot of intensity as a function of the mass-to-charge ratio. This dual integrated system is assembled by attaching a DMS device to the inlet of a mass spectrometer. Isobaric separations take place between the DMS electrodes and separated compounds pass into the inlet of the MS for mass analysis. SCIEX has commercialized DMS/MS systems under the trade names SelexION technology and SelexION+ technology.

Over the past few decades DMS-MS analysis has emerged as a significant development in the science industry. The utility of chemical modifiers to support DMS function to separate compounds have been discussed in a number of studies. For instance, Schneider, B.B., Covey, T.R., Nazarov, E.G., “DMS-MS separations with different gas modifiers”, Int. J. Ion Mobil. Spec. (2013) 16:207-216 (DOI 10.1007/s12127-013-0130-8), incorporated herein by reference, provided systematic experimental data for a 140 chemical mixture in the presence and absence of a range of chemical modifiers. FIG. 1 from Schneider et al. illustrated the bulk separation of the 140 chemicals in mixture with and without the presence of isopropanol. While some overlap remained with the modifier, the spread over CoV was greatly enhanced with the modifier. The main conclusion of Schneider et al. was to demonstrate that different modifiers have different effect on compounds and it is more efficient when trying modifiers on a set of compounds to select modifiers with different effect, i.e. orthogonal modifiers, before trying modifiers with similar effect.

However, there has been difficulty recognized in separating certain interfering compounds, including isobaric compounds. For this reason LC-MS has remained the standard technique when required to distinguish between and separate similar compounds during analysis. An example of this problem arises in the field of clinical sample analysis where a panel of compounds, such as opioids or barbiturates are being tested for. In conducting such tests it is necessary to distinguish between different similar compounds as well as isobaric compounds that have the same composition but different structure. It has generally been understood that similar compounds, as well as isobaric compounds, are not always separable by DMS.

For example, Porta, T., Varesio, E., and Hopfgartner, G., “Gas-phase separation of Drugs and Metabolites using Modifier-Assisted Differential Ion Mobility Spectrometry Hyphenated to Liquid Extraction Surface Analysis and Mass Spectrometry, Anal. Chem., 2013, 85, 24, 11771-11779 (DOI: 10.1021/ac4020353) describe the use of modifiers to assist in separating certain isomeric metabolites. While the modifiers were successful in separating some of the compounds, they were not able to separate all of the isomeric metabolites (e.g. see FIG. 2).

Similarly, the separability of hydromorphone, norcodeine, morphine, and codeine was reported in Wei, M.S., Kemperman, R.H.H., Yost, R.A., “Effects of Solvent Vapor Modifiers for the Separation of Opioid Isomers in Micromachined FAIMS-MS”, J. Am. Soc. Mass Spectrom. (2019) 30:731-742 (DOI: 10.1007/s13361-019-02175-w. In the reference the authors were able to demonstrate the separation of morphine and norcodeine using acetonitrile as a modifier, however they demonstrated the inability to separate morphine, hydromorphone and codeine to an analytically useful degree. FIG. 4b) and FIG. 7 in Wei et al. demonstrate significant overlap between hydromorphone, morphine, and codeine, which indicates that neither an acetonitrile modifier nor an ethyl acetate modifier are capable of separating between all four of these compounds. The other modifiers demonstrated in Wei et al. showed even worse performance as compared with acetonitrile and ethyl acetate.

The problem with only being able to separate some of the isomeric compounds makes the system unsuitable for general analytical work where a sample of unknown composition is provided and the analysis results are expected to identify what compounds are in the sample. While this problem arises in a number of fields, it has particular relevance to clinical sample where compounds of similar composition may have different effect based on their structure.

The inventors have identified a need for systems and methods for operating a DMS to enable separation of compounds, including interfering compounds.

### SUMMARY

It is an aspect of the present invention to provide systems and methods for separating isobaric species in a DMS. In some embodiments, a combination of separation by fragmentation, a selected modifier, and one or more selected DMS field values may be used to separate a panel of compounds including at least one set of compounds of a same mass.

In an embodiment, a panel of interfering opioid compounds may be separated in a DMS with the addition of an acetate modifier.

In an embodiment, a panel of interfering benzo compounds may be separated in a DMS with the addition of an acetate modifier.

In an aspect, there is provided a method for separating and distinguishing between all isotopic or isobaric opioid and/or benzodiazepine species within a sample. The method comprises introducing ions of the sample to an inlet of a differential mobility spectrometer (DMS), introducing a transport gas to carry the ions through the DMS, supplying an acetate modifier to the transport gas to modify the differential mobility of the ions, transporting the ions through the DMS in the presences of the acetate modifier and selectively transporting each of the species by selectively applying a corresponding compensation voltage for that species to allow that species to transport through and exit from the DMS.

In an embodiment, the acetate modifier is selected from the group comprising methylacetate, ethylacetate, propylacetate, and butylacetate.

In other embodiments, the acetate modifier is introduced to the transport gas at greater than 1.5% volume/volume, greater than 2% volume/volume or greater than 3% volume/volume.

In another embodiment, the isotopic or isobaric opioid and/or benzodiazepine species are selected from at least one of the following groups: norhydrocodone, morphine and hydromorphine; codeine and hydrocodone; noroxycodone, oxymorphone and dihydocodeine; carbamazepine 10, 11 - epoxide and oxcarbazepine; mirtazapine and desmethyldoxepin; 7-aminoflunitrazepam, diazepam, 7-aminoclonazepam and oxazepam; chlordiazepoxide and temazepam; olanzapine, desmethylclozapine, flunitrazepam, amoxapine and clonazepam; and midazolam and clozapine.

In another embodiment, the method includes supplying at least a portion of the separated ions to a mass spectrometer for qualitative and/or quantitative analysis of the compounds and isobaric species of interest.

In another aspect, a method of separating and distinguishing between a plurality of compounds within a sample is provided, wherein the method comprises introducing ions of the sample to an inlet of the differential mobility spectrometer (DMS), introducing a transport gas to carry the ions through the DMS, supplying an acetate modifier to the transport gas to modify the differential mobility of the ions, transporting the ions through the DMS in the presences of the acetate modifier and selectively transporting each of the species by selectively applying a corresponding compensation voltage for that species to allow that species to transport through and exit from the DMS; wherein the plurality of compounds is selected from at least one of the following groups: norhydrocodone, morphine and hydromorphine; codeine and hydrocodone; noroxycodone, oxymorphone and dihydocodeine; carbamazepine 10, 11 - epoxide and oxcarbazepine; mirtazapine and desmethyldoxepin; 7-aminoflunitrazepam, diazepam, 7-aminoclonazepam and oxazepam; chlordiazepoxide and temazepam; olanzapine, desmethylclozapine, flunitrazepam, amoxapine and clonazepam; and, midazolam and clozapine.

In another embodiment, the foregoing method includes supplying at least a portion of the separated ions to a mass spectrometer for qualitative and/or quantitative analysis of the compounds and isobaric species of interest.

In another embodiment, the separation of the sample includes separating norhydrocodone, morphine and hydromorphine.

In another embodiment, the separation of the sample includes separating codeine and hydrocodeine.

In another embodiment, the separation of the sample includes separating noroxycodone, oxymorphone and dihydrocodein.

In another embodiment, the separation of the sample includes separating carbamazepine 10, 11 - epoxide and oxcarbazepine.

In another embodiment, the separation of the sample includes separating mirtazapine and desmethyldoxepin.

In another embodiment, the separation of the sample includes separating 7-aminoflunitrazepam, diazepam, 7-aminoclonazepam and oxazepam.

In another embodiment, the separation of the sample includes separating chlordiazepoxide and temazepam.

In another embodiment, the separation of the sample includes separating olanzapine, desmethylclozapine, flunitrazepam, amoxapine and clonazepam.

In another embodiment, the separation of the sample includes separating midazolam and clozapine.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A is a simplified schematic of a planar differential mobility spectrometer.

FIG. 1B is a simplified schematic of a FAIMS differential mobility spectrometer.

FIG. 2 illustrates an exemplar opioid panel of compounds to be analyzed.

FIG. 3A illustrates the chemical structures of a group of isobaric opioid species: hydromorphone, norhydrocodone and morphine, respectively.

FIG. 3B illustrates MS analysis of a sample containing the isobaric species of FIG. 3A.

FIG. 3C illustrates MS / MS analysis of separate samples of each of the isobaric species of FIG. 3A.

FIG. 4 shows the alpha curves for the three species illustrated in FIGS. 1 - 3, in the absence of chemical modifiers.

FIGS. 5A, 5B and 5C show alpha curves for the three isobaric opioid species of FIGS. 1 - 3 in the presence of isopropanol, acetonitrile and ethylacetate modifiers, respectively.

FIG. 6A shows separation data for the three isobaric opioid species of FIGS. 1 -3 at different DMS resolution settings.

FIG. 6B) is a comparison of separations for a group of five isobaric opioid species using ethylacetate modifier.

FIG. 7 is a schematic representation of a differential mobility spectrometer/mass spectrometer system, according to an embodiment.

FIG. 8 shows a method that can be used with the differential mobility spectrometer/mass spectrometer system of FIG. 7, for separating and distinguishing between isotopic or isobaric opioid and/or benzodiazepine species within a sample, according to an aspect.

FIG. 9 compares the separation of chlordiazepoxide from temazepam by LC, no modifier, and using ethylacetate with DMS

FIG. 10 illustrates the separability of opioids with DMS using different modifiers.

### DETAILED DESCRIPTION OF THE PREFERRED EMBODIMENTS

Conventional analytical liquid chromatography (LC) separation of isobars is not adequate for high speed analysis of samples, taking several minutes to run each sample to achieve adequate separation between similar compounds in the sample. The use of a differential mobility spectrometer (DMS) has been proposed as an alternative separation mechanism for separation of compounds within a mixture as it permits faster throughput by avoiding the requirement for a retention time as compounds physically separate in a column. DMS achieves separation by taking advantage of differences in ion mobility as they travel through a gaseous environment under the influence of a varying electric field.

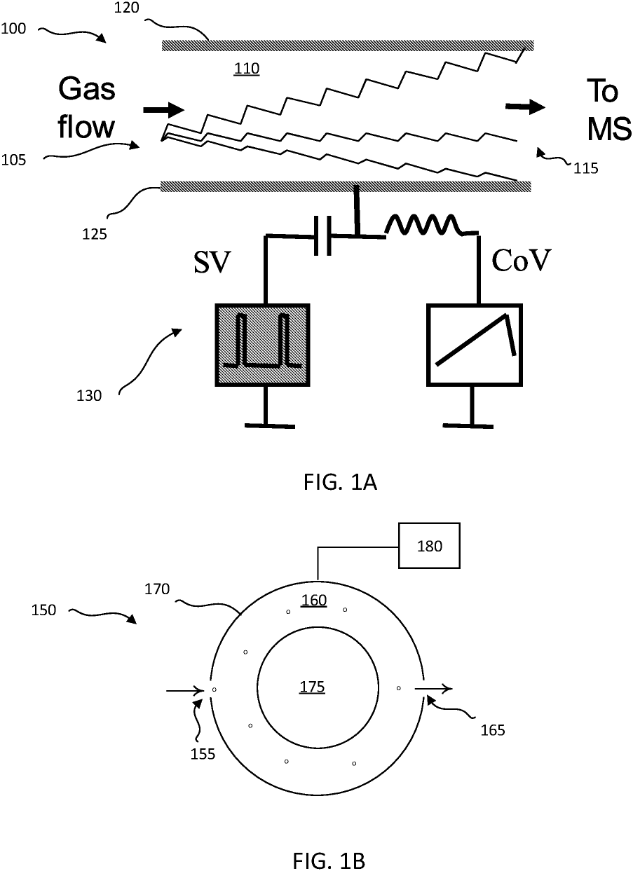

Referring to FIG. 1A, a simplified schematic of a planar DMS 100 is presented. The planar DMS 100 is made up of a pair of opposed electrodes 120, 125 that define a separation region 110. A DMS inlet 105 permits the introduction of a transport gas and sample ions into the planar DMS 100 for separation in the separation region 110. Sample ions that exhibit mobility that matches the conditions within the separation region 110 are allowed to pass out through the DMS outlet 115. An electrode driving source 130 provides the varying separation voltage (SV) and compensation voltage (CoV) to one of the electrodes 120, 125.

FIG. 1B illustrates a simplified schematic of a FAIMS DMS 150. The FAIMS DMS 150 includes a pair of electrodes 170, 175 that define a curved separation region 160. The FAIMS DMS inlet 155 allows introduction of a transport gas and sample ions into the FAIMS DMS 150 for separation in the curved separation region 160. Sample ions that exhibit mobility that matches the conditions within the curved separation region 160 are allowed to pass out through the FAIMS DMS outlet 165. An electrode driving source 180 provides the varying separation voltage (SV) and compensation voltage (CoV) to one of the electrodes 170, 175.

For simplicity, this application will use the term DMS to refer collectively to both the planar DMS 100, the FAIMS DMS 150, and other similar known differential mobility spectrometer architectures.

The inventors were presented with the problem of distinguishing between a panel of interfering compounds, such as interfering opioids or interfering benzos, within a given sample by analysis that could be completed within a minute or less. As an example, for instance, the sample may be a clinical sample such as a measure of blood and the required analysis is to identify and measure individual compounds that may be present within the sample. This problem requires a system and method able to discriminate between compounds which may not be present in any given sample, but would lead to an erroneous result if two or more of the interfering compounds were present.

Prior methods to conduct MS analysis on a sample to discriminate and/or measure between a panel of compounds rely upon LC-MS to achieve compound separation. In LC-MS a solvent gradient is run with different compounds being released from the LC column at different times at specific relative solvent concentrations. Since similar compounds by mass and structure may have considerably different mobility concentrations when subjected to an LC gradient, the LC column has successfully been used to separate most compounds for analytical analysis. The main limitations of LC analysis include: i) system complexity; ii) error due to column malfunction; and, iii) time required to analyze a sample is dictated by the elution time from the column which can run 10 minutes or more per sample depending upon the analysis required. This has led to limitations in MS adoption for situations that require sample results in relatively quick order, such as in a clinical or hospital setting where a patient’s diagnosis would benefit from MS analysis results to inform a treatment plan.

The inventors proposed to substitute a DMS for the LC to permit faster MS sample analysis, and meet the needs of end users in clinical and other settings. While it was known that certain compounds could be separated by DMS, it has been understood that not all compounds could be separated. Furthermore, it was commonly understood that the compounds of interest, namely opioids and benzos, were not all separable by DMS.

The literature reports on successful separation of two or three interfering compounds specifically added to a prepared experimental sample, but don’t provide a solution for separating and or discriminating between all potential interfering compounds within a complicated compound panel that might be present in a real world sample. The issue in this problem is that a successful method for real world sample analysis must reliably separate and discriminate between all of the panel compounds in order to return an analytically useful result. As a result DMS-MS analysis has been limited to specific cases where analysis does not require separation of interfering isobaric compounds such as opioids or benzos. Surprisingly, through extensive experimentation and analysis of the problem the inventors have identified a system and method for reliably separating all opioid and benzo compounds using DMS.

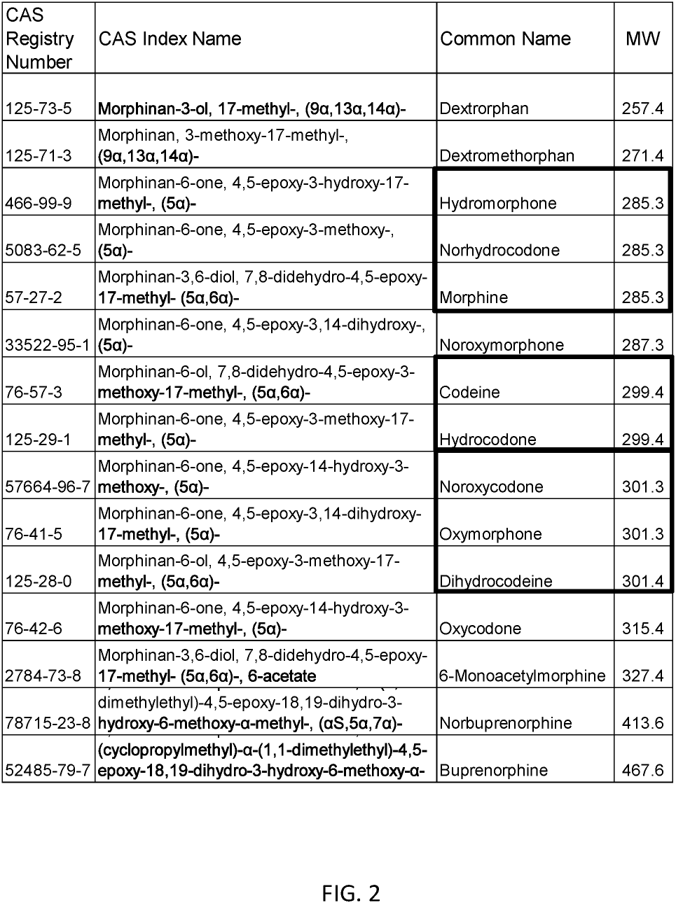

FIG. 2 provides an example of a panel of opioids that may be of interest for an analytical test. A successful analysis requirement is that during analysis of a given sample the system and method is operative to detect the presence of, and distinguish between, all compounds in the panel. Practically, the analysis system and method should be able to receive a single sample for analysis and then conduct the analysis and deliver an analytically useful result in less time than conventional LC-MS analysis. While some of the compounds in this opioid panel are separable by molecular weight (MW), it is evident that there are three groups of compounds in the panel that each share a same MW: group 1 (285.34 MW): hydromorphone, norhydrocodone, morphine; group 2 (299.36 MW) codeine, hydrocodone; and, group 3 (301.34 MW) noroxycodone, oxymorphone. Since the compounds in each of these groups share a same MW, their ions are not separable by mass in the Q1 cell of a mass spectrometer.

In many cases a standard analysis will require the system and method to report on all compounds within the panel. Depending upon user requirements, however, a given analysis may not require for identification of, or discrimination between, all compounds in the panel. Typically, however, a useful analysis will at least require discrimination between the interfering compounds in at least one of the groups of a same MW.

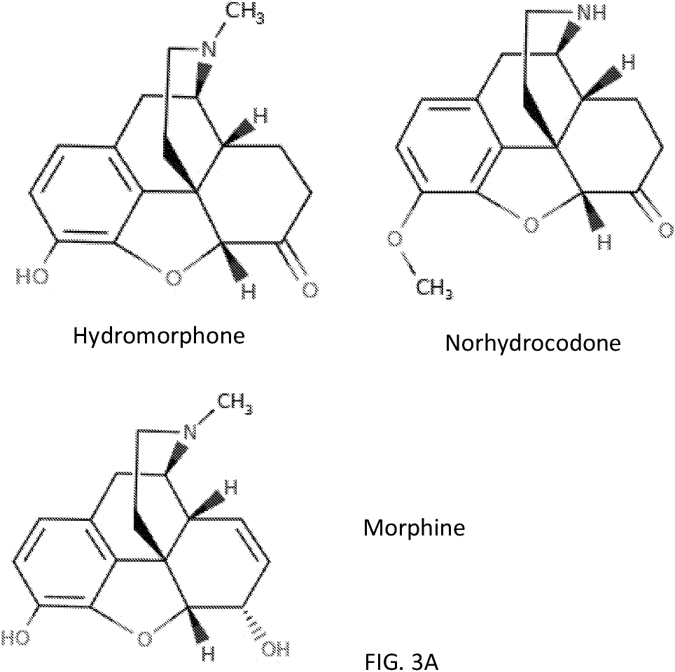

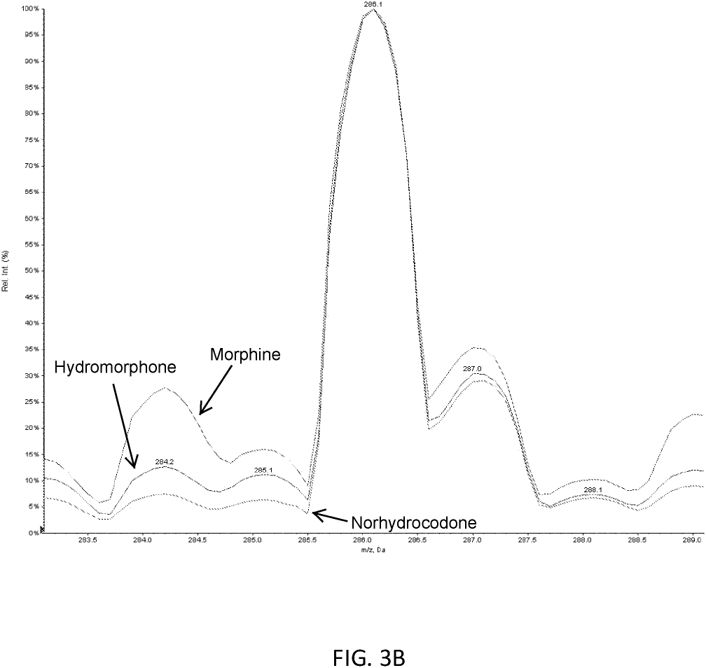

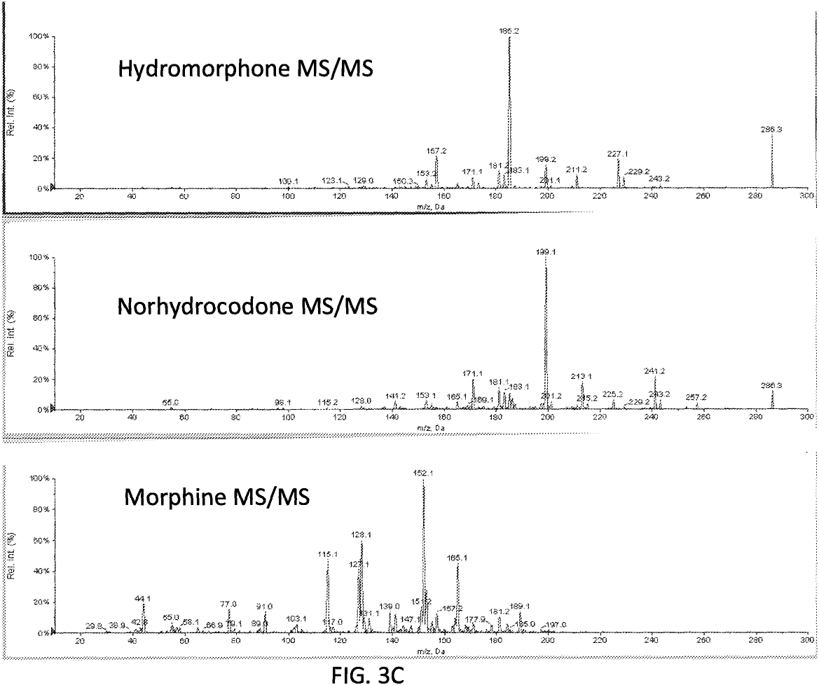

FIG. 3A illustrates the chemical structure for the isobaric opioid compounds in group 1: hydromorphone, norhydrocodone, morphine. As is evident, these three compounds have identical atomic components with only small differences in structure, i.e. the location of the atomic components within the structure.

FIG. 3B illustrates a mass spectrometry analysis at Q1 of the MS of a sample containing a mixture of the three isobaric opioid compounds from group 1 without LC separation prior to ionization. FIG. 3B shows, as expected, complete overlap around their mass of 285.34, as well as overlap at 284.2, 285.1, 287.0, and 288.1. As demonstrated, the three isobaric opioid compounds from group 1 cannot be separated or distinguished using Q1 MS analysis.

FIG. 3C illustrates an MS/MS analysis conducted separately on each of the three isobaric compounds from FIG. 3A. FIG. 3C illustrates that each of the three compounds have some interference at important m/z, such as 185 and 199....As demonstrated, the three isobaric compounds from group 1 cannot be separated or distinguished using MS/MS analysis.

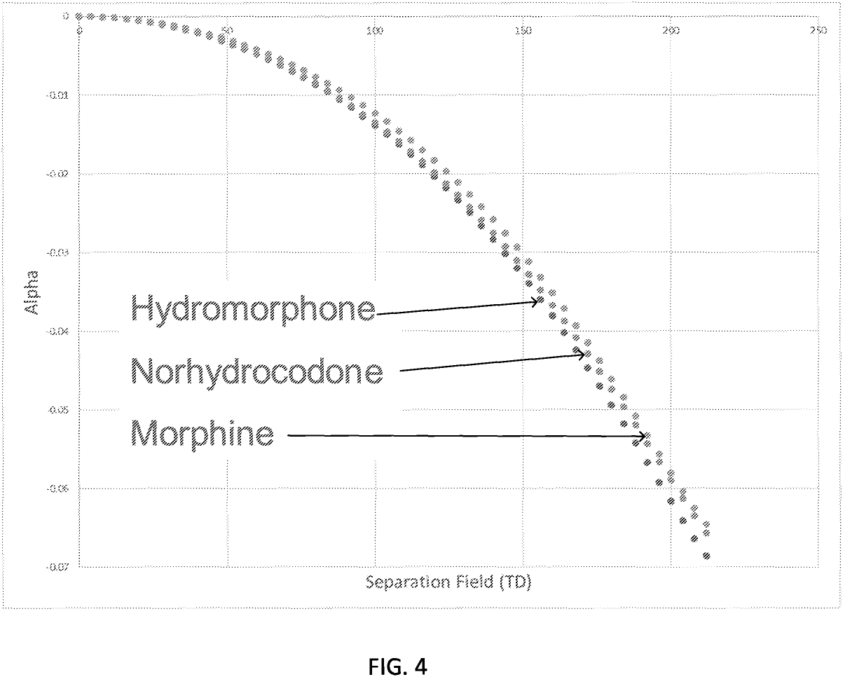

FIG. 4 shows the alpha curves for these three species in the absence of chemical modifiers. As discussed above, alpha (α) represents the normalized difference between the high and low field mobility for an ion. Two species are generally considered separable when the difference in alpha is greater than about 0.005. As shown in FIG. 4, the alpha curves are very similar for hydromorphone, norhydrocodone and morphine, such that it is not possible to baseline separate them.

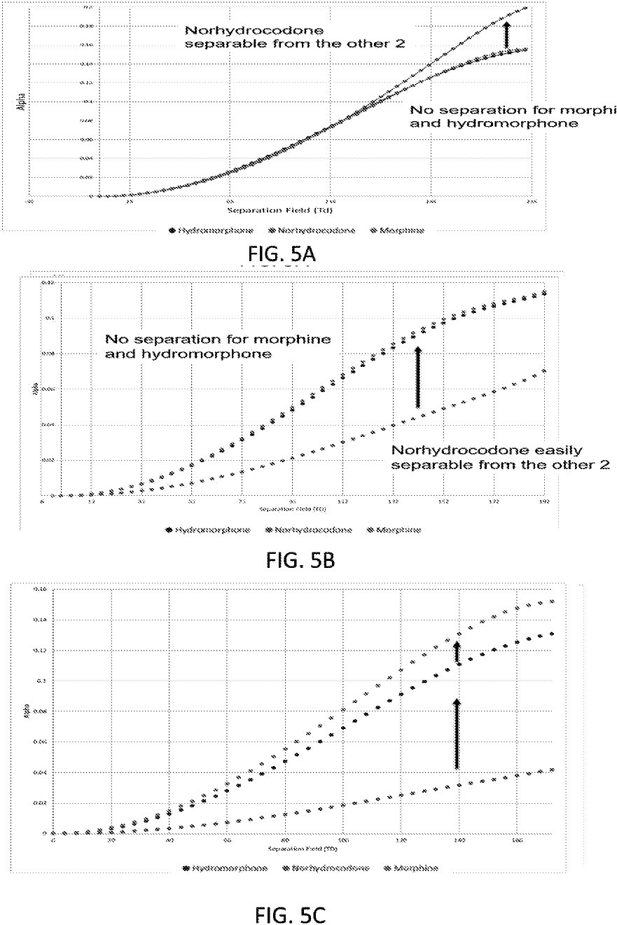

FIG. 4 shows the alpha curves for hydromorphone, norhydrocodone and morphine when isopropanol is added to the transport gas. It will be noted that the alpha curve for norhydrocodone is substantially different than the curves for the other isobars, indicating that norhydrocodone may be baseline separated from hydromorphone and morphine whereas morphine and hydromorphone are not separated with the addition of isopropanol. Similar results are shown in FIG. 5B, using acetonitrile as the modifier.

As discussed above, the inventors have discovered that an acetate modifier generally provides the best separation for interfering opioid and benzo molecules using a DMS system for gas phase separation.

FIG. 5C shows alpha curves for the same group of compounds with the addition of an acetate modifier (ethylacetate), indicating baseline separation of all three species and that a standard DMS system can be used as a gas phase separation device without a liquid chromatograph (LC) column, although in some embodiments a “trap” column that runs minimal to no gradient may be used to provide sample cleaning.

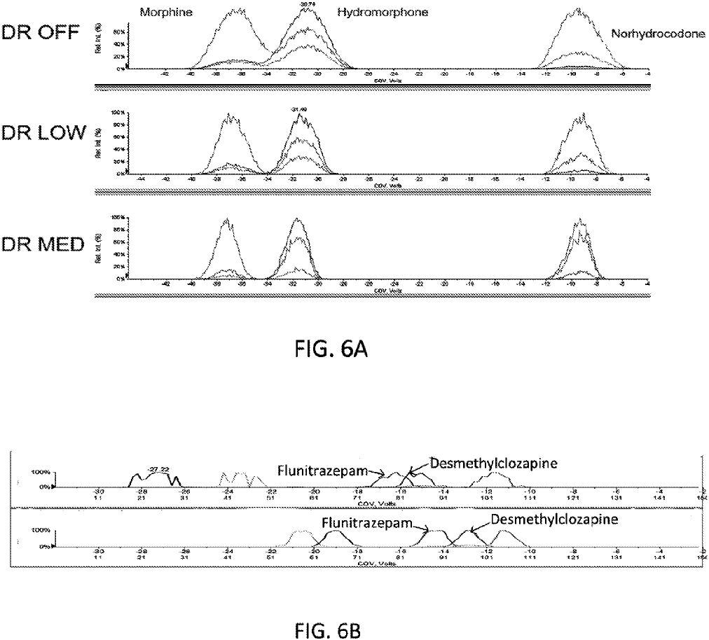

FIG. 6A shows separation data taken for a mixture of hydromorphone, norhydrocodone and morphine using three different DMS resolution settings, when ethylacetate is added to the transport gas at 3%. In the top pane, the DMS throttle gas setting is off, while in the middle and bottom panes the DMS throttle gas settings are low and medium, respectively. It will be noted from FIG. 6A that when ethylacetate is added to the transport gas, it is possible to baseline resolve the three isobars.

FIG. 6B shows a comparison of the separations achieved using ethylacetate (top pane) and acetonitrile (bottom pane). When operating with the ethylacetate modifier, partial overlap of the traces that correspond to flunitrazepam and desmethylclozapine can be seen, whereas the acetonitrile modifier provides baseline separation for the five compounds in the 313-316.7 grouping.

Experimentation using multiple reaction monitoring (MRM) with a triple quadrupole mass spectrometer has shown that baseline separation between 5 different drug entities: flunitrazepam, olanzapine, desmethylclozapine, amoxapine and clonazepam, using the conventional LC/MS method resulted in interference to varying degrees between the samples due to an intense peak at time 9.09 min in each sample.

Table 1 shows an example of an interference matrix generated for a group of 5 isobaric or near isobaric benzo compounds, where the presence of signal (+) or the absence of signal (-) is noted in the column for each of the 5 MRM transitions for this grouping of compounds.

TABLE 1

| | | | | | |
|---|---|---|---|---|---|
| Injected Sample | Clonazepam | Olanzapine | Desmethylclozapine | Flunitrazepam | Amoxapine |
| Clonazepam | + | - | - | - | - |
| Olanzapine | - | + | + | - | - |
| Desmethylclozapine | - | + | + | + | + |
| Flunitrazepam | + | + | + | + | + |
| Amoxapine | + | + | + | + | + |

It is clear from the results in the table that clonazepam is the only compound in this grouping that does not provide an interference in the MRM channel of other compounds.

Tables 2A and 2B summarize data from experiments conducted for 25 drugs from opioid and benzo drug panels, respectively, from which it will be noted that isopropanol and acetonitrile work for some of the groups of isobars, but not for others, whereas ethylacetate provides baseline separation between all of the opioid isobaric groupings and all of the benzo species except for the 313-316.7 grouping, where separation was not fully baselined.

TABLE 2A

Opioid Panel

| | | | | |
|---|---|---|---|---|
| | No Modifiers | Isopropanol Modifier | Acetonitrile Modifier | Ethylacetate Modifier |
| Norhydrocodone Separation from Morphine/Hydromorphone (286 s) | No Separation | No Separation | No Separation | Separation |
| Codeine & Hydrocodone (300 s) | Separation | No Separation | Separation | Separation |
| Noroxycodone & Oxymorphone & Dihydrocodeine (302 s) | No Separation | Separation | Separation | Separation |

TABLE 2B

Benzo Panel

| | | | | |
|---|---|---|---|---|
| | No Modifiers | Isopropanol Modifier | Acetonitrile Modifier | Ethylacetate Modifier |
| Carbamazepine 10, 11 - epoxide & Oxcarbazepine (253 s) | No Separation | Separation | No Separation | Separation |
| Mirtazapine & Desmethyldoxepin (266 s) | No Separation | Separation | No Separation | Separation |
| 7-aminoflunitrazepam, Diazepam, 7-aminoclonazepam & Oxazepam (284 -287 s) | No Separation | Separation | Separation but not fully baselined | Separation |
| Chlordiazepoxide & Temazepam (300 and 301 s) | Separation | No Separation | Separation | Separation |
| Olanzapine, Desmethylclozapine, flunitrazepam, amoxapine & clonazepam (313 -316.7 s) | No Separation | No Separation | Separation | Separation but not fully baselined |
| Midazolam & Clozapine (326.8 and 327.8 s) | No Separation | Separation | Separation | Separation |

As discussed above, according to an aspect there is provided a method and apparatus for separating compounds and isobaric species of interest comprising opioids or benzodiazepines in a differential mobility spectrometer/mass spectrometer system.

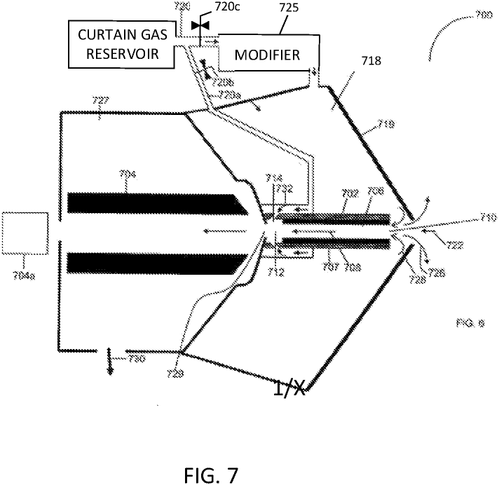

Turning to FIG. 7, a differential mobility spectrometer/mass spectrometer system 700, is shown in connection with which the method for separating isobaric species of opioids or benzodiazepines may be performed. The differential mobility spectrometer/mass spectrometer system 700 comprises a differential mobility spectrometer 702 and a first vacuum lens element 704 of a mass spectrometer (hereinafter generally designated mass spectrometer 704). Mass spectrometer 704 also comprises mass analyzer elements 704a downstream from vacuum chamber 727. Ions can be transported through vacuum chamber 727 and may be transported through one or more additional differentially pumped vacuum stages prior to the mass analyzer indicated schematically as mass analyzer elements 704a. For instance, in one embodiment a triple quadrupole mass spectrometer may comprise three differentially pumped vacuum stages. The third vacuum stage may contain a detector, as well as two quadrupole mass analyzers with a collision cell located between them. It will be apparent to those of skill in the art that there may be other ion optical elements in the system that have not been described. This example is not meant to be limiting as it will also be apparent to those of skill in the art that the differential mobility spectrometer/mass spectrometer coupling described can be applicable to many mass spectrometer systems that sample ions from elevated pressure sources. These may include time of flight (TOF), ion trap, quadrupole, or other mass analyzers as known in the art.

The differential mobility spectrometer 702 comprises plates 706 and an electrical insulator 707 along the outside of plates 706. The plates 706 surround a transport gas 708 that drifts from an orifice 710 of the differential mobility spectrometer to an outlet 712 of the differential mobility spectrometer 702. The insulator 707 supports the electrodes and isolates them from other conductive elements. The outlet 712 of the differential mobility spectrometer 702 releases the transport gas into a juncture or baffle chamber 714 defined by baffles 716, which juncture chamber 714 defines a path of travel for ions between the differential mobility spectrometer 702 and the mass spectrometer 704. In some embodiments, the outlet 712 of the differential mobility spectrometer 702 is aligned with the inlet of the mass spectrometer 704 to define the ion path of travel therebetween, while the baffles 716 are spaced from this path of travel to limit interference of the baffles 716 with the ions 722 traveling along the path of travel.

The differential mobility spectrometer 702 and juncture chamber 714 are both contained within a curtain chamber 718, defined by curtain plate (boundary member) 719 and supplied with a curtain gas from a curtain gas reservoir 720. The curtain gas reservoir 720 provides the curtain gas to the interior of the curtain chamber 718. Ions 722 are provided from an ion source (not shown) and are emitted into the curtain chamber 718 via orifice 710. The pressure of the curtain gas within the curtain chamber 718 provides both a curtain gas outflow 726 out of orifice 710, as well as a curtain gas inflow 728 into the differential mobility spectrometer 702, which inflow 728 becomes the transport gas 708 that carries the ions 722 through the differential mobility spectrometer 702 and into the juncture chamber 714. The curtain plate 719 may be connected to a power supply to provide an adjustable DC potential to it.

As illustrated in FIG. 7, first vacuum lens element 704 of the mass spectrometer 704 is contained within a vacuum chamber 727, which can be maintained at a much lower pressure than the curtain chamber 718. As a result of the significant pressure differential between the curtain chamber 718 and the vacuum chamber 727, the transport gas 708 is drawn through the differential mobility spectrometer 702, the juncture chamber 714 and, via vacuum chamber inlet 729, into the vacuum chamber 727 and first vacuum lens element 704. As shown, the mass spectrometer 704 can be sealed to (or at least partially sealed), and in fluid communication with the differential mobility spectrometer, via the juncture chamber, to receive the ions 722 from the differential mobility spectrometer 702.

As shown, the baffles 716 of the curtain chamber comprise a controlled leak or gas port 732 for admitting the curtain gas into the juncture chamber 714. Within the juncture chamber 714, the curtain gas becomes a throttle gas that throttles back the flow of the transport gas 708 through the differential mobility spectrometer 702. Specifically, the throttle gas within the juncture chamber 714 modifies a gas flow rate within the differential mobility spectrometer 702 and into the juncture chamber 714, thereby controlling the residence time of the ions 722 within the differential mobility spectrometer 702. By controlling the residence time of the ions 722 within the differential mobility spectrometer 702, resolution and sensitivity can be adjusted. That is, increasing the residence times of the ions 722 within the differential mobility spectrometer 702 can increase the resolution, but can also result in additional losses of the ions, reducing sensitivity. In some embodiments it can therefore be desirable to be able to precisely control the amount of throttle gas that is added to the juncture chamber 714 to provide a degree of control to the gas flow rate through the differential mobility spectrometer 702, thereby controlling the tradeoff between sensitivity and selectivity. In the embodiment of FIG. 7, the inflow of throttle gas from the curtain chamber 718 can be controlled by controlling the size of the leak provided by the gas port 732.

The baffles can be configured to provide a randomizer surface member, and the gas port 732 can be oriented to direct the throttle gas at least somewhat against the baffles 716 and randomizer surface to disburse the throttle gas throughout the juncture chamber 714. In one embodiment, the gas port 732 introduces the throttle gas without disrupting the gas streamlines between the differential mobility spectrometer 702 and the mass spectrometer inlet 729.

As described above and as known in the art, RF voltages, often referred to as separation voltages (SV), can be applied across an ion transport chamber of a differential mobility spectrometer perpendicular to the direction of transport gas 708. The RF voltages may be applied to one or both of the DMS electrodes comprising the differential mobility spectrometer. The tendency of ions to migrate toward the walls and leave the path of the DMS can be corrected by a DC potential often referred to as a compensation voltage (CoV). The compensation voltage may be generated by applying DC potentials to one or both of the DMS electrodes comprising the differential mobility spectrometer. As is known in the art, a DMS voltage source (not shown) can be provided to provide both the RF SV and the DC CV. Alternatively, multiple voltage sources may be provided.

Curtain gas reservoir 720 comprises a controllable valve 720b that can be used to control the rate of flow of the throttle gas into the juncture chamber 714 via conduit branch 720a. Conduit or curtain gas reservoir 720 also flows to a modifier supply 725 via a valve 720c in fluid communication with the curtain gas supply for adding a modifier which is ultimately pumped into the differential mobility spectrometer 702 by the vacuum maintained in the vacuum chamber 727. As noted above, the curtain gas and transport gas are one and the same; thus, adding the modifier to the curtain gas adds simplicity to the system 700.

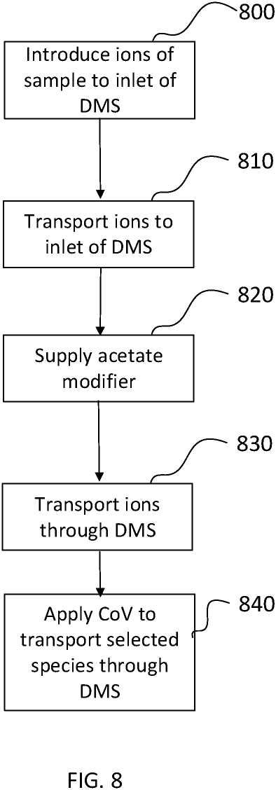

FIG. 8 shows a method according to an aspect of this specification, that can be used with the differential mobility spectrometer/mass spectrometer system 700 of FIG. 7, for separating and distinguishing between all isotopic or isobaric opioid and/or benzodiazepine species within a sample. At 800, ions of a sample are introduced to orifice 710 of DMS 702. At 810, transport gas 708 is introduced to carry the ions through the DMS. At 820, an acetate modifier is supplied to the transport gas via modifier supply 725 to modify the differential mobility of the ions. In an embodiment, the acetate modifier is selected from the group comprising methylacetate, ethylacetate, propylacetate, and butylacetate. At 830, the ions are transported through the DMS 702 in the presences of the acetate modifier. Then, at 840, each of the species is selectively transported by selectively applying a corresponding compensation voltage for that species to allow that species to transport through and exit from the DMS 702.

In an embodiment, the acetate modifier is introduced to the transport gas at greater than 1.5% volume/volume, for enhanced separation of species. In another embodiment, the acetate modifier is introduced to the transport gas at greater than about 2% volume/volume. In yet another embodiment, the acetate modifier is introduced to the transport gas at about 3% volume/volume.

As discussed above with reference to Table 2B, the acetate modifier provides baseline separation between all the opioid isobaric groupings and all the benzo species except flunitrazepam and desmethylclozapine, whereas the acetonitrile modifier provides baseline separation for the five compounds in the 313-316.7 grouping.

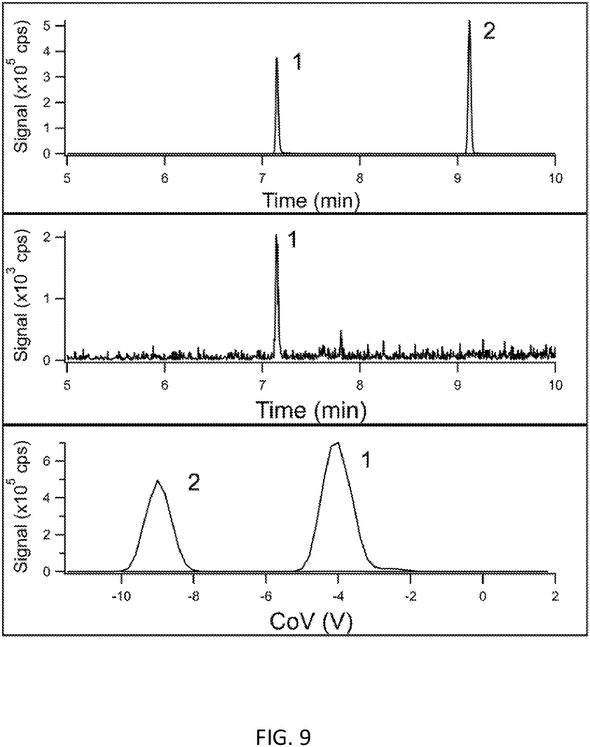

FIG. 9 illustrates two compounds, chlordiazepoxide and temazepam, that are separable by LC in the top frame, inseparable without LC in the second frame, and separable by DMS using ethylacetate as the modifier in the bottom frame.

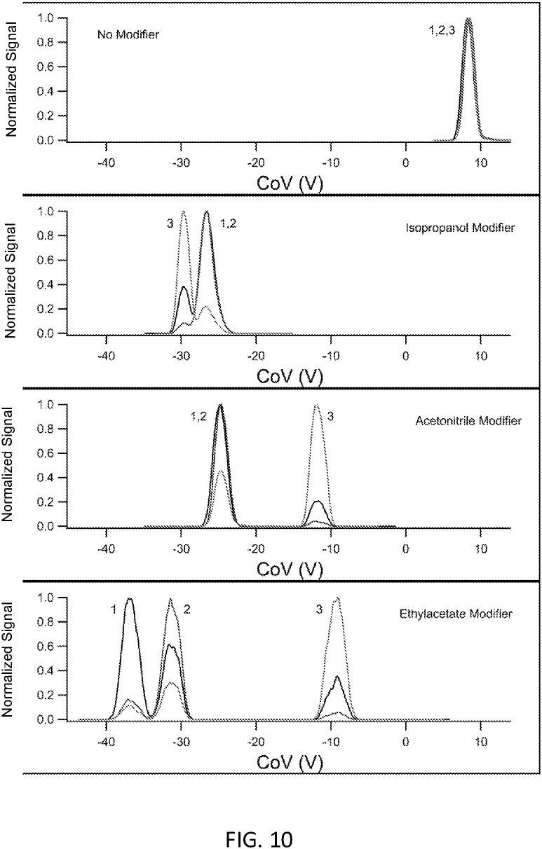

FIG. 10 illustrates the performance of various modifiers in separating a group of opiods (morphine, hydromorphone, and norhydrocodone). As illustrated, the acetate modifier is able to separate all three compounds which are not separable by isopropanol, acetonitrile, or no modifier.

The many features and advantages of the invention are apparent from the detailed specification and, thus, it is intended by the appended claims to cover all such features and advantages of the invention that fall within the scope of the claims. Further, since numerous modifications and changes will readily occur to those skilled in the art, it is not desired to limit the invention to the exact construction and operation illustrated and described, and accordingly all suitable modifications and equivalents may be resorted to, falling within the scope of the claims.

1. A method for separating and distinguishing between all isotopic or isobaric opioid and/or benzodiazepine species within a sample, the method comprising:
introducing ions of the sample to an inlet of a differential mobility spectrometer (DMS);
introducing a transport gas to carry the ions through the DMS;
supplying an acetate modifier to the transport gas to modify the differential mobility of the ions; and
transporting the ions through the DMS in the presences of the acetate modifier and selectively transporting each of the species by selectively applying a corresponding compensation voltage for that species to allow that species to transport through and exit from the DMS.

2. The method of claim 1 wherein the acetate modifier is selected from the group comprising methylacetate, ethylacetate, propylacetate, and butylacetate.

3. The method of claim 1 wherein the acetate modifier is introduced to the transport gas at greater than about 1.5% volume/volume.

4. The method of claim 1, wherein the acetate modifier is introduced to the transport gas at greater than about 2% volume/volume.

5. The method of claim 1 wherein the acetate modifier is introduced to the transport gas at about 3% volume/volume.

6. The method of claim 1, wherein the isotopic or isobaric opioid and/or benzodiazepine species are selected from at least one of the following groups:
i) norhydrocodone, morphine and hydromorphine;
ii) codeine and hydrocodone;
iii) noroxycodone, oxymorphone and dihydocodeine;
iv) carbamazepine 10, 11 - epoxide and oxcarbazepine;
v) mirtazapine and desmethyldoxepin;
vi) 7-aminoflunitrazepam, diazepam, 7-aminoclonazepam and oxazepam;
vii) chlordiazepoxide and temazepam;
viii) olanzapine, desmethylclozapine, flunitrazepam, amoxapine and clonazepam; and
ix) midazolam and clozapine.
